(19) United States
(12) Patent Application Publication
(10) Pub. No.: US 2024/0386344 A1
(43) Pub. Date: Nov. 21, 2024

(54) NOTIFICATION APPARATUS AND METHOD FOR IMPROVING TRAVEL MAAS

(71) Applicant: TOYOTA JIDOSHA KABUSHIKI KAISHA, Toyota-shi (JP)

(72) Inventors: Yu NAGATA, Chofu-shi (JP); Shun HASHIMOTO, Kiyosu-shi (JP); Kota YAMAZAKI, Kasugai-shi (JP); Akane MASAKI, Nisshin-shi (JP); Wataru ETO, Nagoya-shi (JP); Makoto AKAHANE, Yokohama-shi (JP)

(73) Assignee: TOYOTA JIDOSHA KABUSHIKI KAISHA, Toyota-shi (JP)

(21) Appl. No.: 18/665,191

(22) Filed: May 15, 2024

(30) Foreign Application Priority Data
May 17, 2023 (JP) 2023-081830

(51) Int. Cl. G06Q 10/0631

(52) U.S. Cl. CPC G06Q 10/063114

(57) ABSTRACT

A notification apparatus includes a communication interface configured to communicate with a terminal apparatus configured to request a service to dispatch a service staff to a location in which a user vehicle is parked, cause the dispatched service staff to move the user vehicle to another location, and supply an energy source to the user vehicle in a location to which the user vehicle is moved, and a controller configured to, upon detecting an act or omission of the service staff against the user vehicle, while the service is provided, that is different from boarding the user vehicle in order to drive the user vehicle, transmit notification data notifying a user of the detected act or omission to the terminal apparatus via the communication interface.

### CROSS-REFERENCE TO RELATED APPLICATION

This application claims priority to Japanese Patent Application No. 2023-081830 filed on May 17, 2023, the entire contents of which are incorporated herein by reference.

### TECHNICAL FIELD

The present disclosure relates to a notification apparatus and a method for improving travel MaaS.

### BACKGROUND

Patent Literature (PTL) 1 discloses a system to provide a service to charge vehicles on behalf of users and a service to dispatch power supply vehicles.

### CITATION LIST

### Patent Literature

PTL 1: JP 2020-107303 A
PTL 2: JP 2022-138177 A
PTL 3: JP 2009-175787 A
PTL 4: JP 2012-043042 A
PTL 5: CN 106157625 A

### SUMMARY

In a service to charge vehicles on behalf of users, the users are likely to feel uneasy about having other people enter the vehicles.

It would be helpful to improve the sense of security in agent-type services such as a service to charge vehicles on behalf of users.

A notification apparatus according to the present disclosure includes:
a communication interface configured to communicate with a terminal apparatus configured to request a service to dispatch a service staff to a location in which a user vehicle is parked, cause the dispatched service staff to move the user vehicle to another location, and supply an energy source to the user vehicle in a location to which the user vehicle is moved; and
a controller configured to, upon detecting an act or omission of the service staff against the user vehicle, while the service is provided, that is different from boarding the user vehicle in order to drive the user vehicle, transmit notification data notifying a user of the detected act or omission to the terminal apparatus via the communication interface.

According to the present disclosure, the sense of security in agent-type services such as a service to charge vehicles on behalf of users is improved.

### BRIEF DESCRIPTION OF THE DRAWINGS

In the accompanying drawings:

FIG. 1 is a diagram illustrating a configuration of a service provision system according to an embodiment of the present disclosure;

FIG. 2 is a block diagram illustrating a configuration of a server apparatus according to the embodiment of the present disclosure;

FIG. 3 is a block diagram illustrating a configuration of a terminal apparatus according to the embodiment of the present disclosure;

FIG. 4 is a flowchart illustrating operations of the service provision system according to the embodiment of the present disclosure;

FIG. 5 is a sequence diagram illustrating an example of a digital key usage procedure according to the embodiment of the present disclosure; and

FIG. 6 is a sequence diagram illustrating another example of the digital key usage procedure according to the embodiment of the present disclosure.

### DETAILED DESCRIPTION

An embodiment of the present disclosure will be described below, with reference to the drawings.

In the drawings, the same or corresponding portions are denoted by the same reference numerals. In the descriptions of the present embodiment, detailed descriptions of the same or corresponding portions are omitted or simplified, as appropriate.

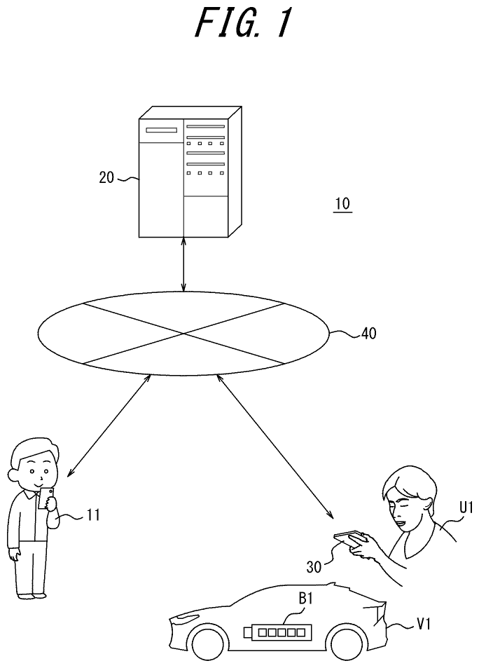

A configuration of a service provision system 10 according to the present embodiment will be described with reference to FIG. 1.

The service provision system 10 includes a server apparatus 20 and a terminal apparatus 30. The server apparatus 20 can communicate with the terminal apparatus 30 via a network 40. The server apparatus 20 can also communicate via the network 40 with a mobile device such as a mobile phone, smartphone, or tablet held by a service staff 11. The terminal apparatus 30 may also be able to communicate via the network 40 with the mobile device held by the service staff 11.

The server apparatus 20 is a computer that belongs to a cloud computing system or other computing system installed in a facility such as a data center. The server apparatus 20 is operated by a supply service provider.

The terminal apparatus 30 is, for example, a mobile device such as a mobile phone, smartphone, or tablet held by each user. The terminal apparatus 30 executes a terminal program to request a supply service.

The supply service is a service to dispatch the service staff 11 to a location in which a user vehicle is parked and supply an energy source to the user vehicle. In the present embodiment, the user vehicle is a BEV. The term “BEV” is an abbreviation of battery electric vehicle. The energy source to be supplied to the user vehicle is electricity. As a variation of the present embodiment, the user vehicle may be another type of automobile such as a gasoline vehicle, a diesel vehicle, a hydrogen vehicle, an HEV, a PHEV, or an FCEV. The term “HEV” is an abbreviation of hybrid electric vehicle. The term “PHEV” is an abbreviation of plug-in hybrid electric vehicle. The term “FCEV” is an abbreviation of fuel cell electric vehicle. The user vehicle may be a MaaS-dedicated vehicle. The term “MaaS” is an abbreviation of Mobility as a Service. The energy source to be supplied to the user vehicle is not limited to electricity, but may be gasoline, diesel fuel, hydrogen, or the like.

The supply service includes at least a charging service or a battery replacement service, and includes both of the charging service and the battery replacement service in the present embodiment. The charging service is a service to supply the energy source to the user vehicle by charging a battery installed in the user vehicle. The battery replacement service is a service to supply the energy source to the user vehicle by replacing the battery installed in the user vehicle with another battery. As a variation of the present embodiment, the supply service may include a service to refuel the user vehicle.

The supply service includes at least an agent-type service. The agent-type service is a service to dispatch the service staff 11 to the location in which the user vehicle is parked, have the dispatched service staff 11 move the user vehicle to another location, and supply the energy source to the user vehicle in the location to which the user vehicle is moved.

In the present embodiment, one of the following combinations of services is selected by each user or automatically, and provided as the supply service: a combination of the charging service and the agent-type service, and a combination of the battery replacement service and the agent-type service. In other words, in the present embodiment, the agent-type charging service or the agent-type battery replacement service is selectively provided. For example, in the agent-type charging service, while a user U1 is not using a user vehicle V1, a worker as the service staff 11 drives the user vehicle V1 from a parking lot to a charging station, charges a battery B1 of the user vehicle V1, and then returns the user vehicle V1. In the agent-type battery replacement service, while the user U1 is not using the user vehicle V1, the worker as the service staff 11 drives the user vehicle V1 from the parking lot to a battery replacement station, replaces the battery B1 of the user vehicle V1 with another battery, and then returns the user vehicle V1.

The network 40 includes the Internet, at least one WAN, at least one MAN, or any combination thereof. The term “WAN” is an abbreviation of wide area network. The term “MAN” is an abbreviation of metropolitan area network. The network 40 may include at least one wireless network, at least one optical network, or any combination thereof. The wireless network is, for example, an ad hoc network, a cellular network, a wireless LAN, a satellite communication network, or a terrestrial microwave network. The term “LAN” is an abbreviation of local area network.

An outline of the present embodiment will be described with reference to FIG. 1.

The terminal apparatus 30 transmits request data to the server apparatus 20. The request data is data requesting the agent-type service. Upon receiving the request data from the terminal apparatus 30, the server apparatus 20 performs a process of dispatching the service staff 11 to a parking location.

The server apparatus 20 functions as a notification apparatus. In other words, upon detecting an act or omission of the service staff 11 against a user vehicle, while the agent-type service is provided, that is different from boarding the user vehicle in order to drive the user vehicle, the server apparatus 20 transmits notification data to the terminal apparatus 30. The notification data is data notifying a user of the detected act or omission.

According to the present embodiment, the user can be notified if the service staff 11 behaves suspiciously or neglects to perform works that should be performed during the provision of the service. Thus, the sense of security in agent-type services is improved.

For example, if the user U1 has received the agent-type charging service, a worker as the service staff 11 drives the user vehicle V1 to a charging station and charges the battery B1 of the user vehicle V1. When the server apparatus 20 detects suspicious behavior of the worker during service provision, it notifies the user U1 of the detected behavior. When the server apparatus 20 detects work negligence by a worker during service provision, it notifies the user U1 of the detected work negligence. The suspicious behavior includes, for example, opening the door of the passenger or rear seat of the user vehicle V1, sitting in the passenger or rear seat of the user vehicle V1, looking into the rear seat of user vehicle V1, or opening the trunk of the user vehicle V1. Boarding the user vehicle V1 is allowed. The work negligence includes, for example, not attaching a dirt-preventive seat cover or not performing a cleaning work requested as an option by the user U1. The suspicious behavior and work negligence are both detected using in-vehicle cameras, such as interior cameras, surround view cameras, or driving recorders, or in-vehicle sensors, such as open/close sensors or load sensors. In-vehicle cameras may normally be used to detect a driver falling asleep or looking away, and may be used to detect the suspicious behavior or the work negligence only when the charging service is in use. Instead of an in-vehicle camera, a camera on a mobile device held by the worker may be used. In such cases, the camera being off may also be detected as suspicious behavior. A partition may be provided in the car that allows the workers only access to the driver seat.

The case in which the user U1 receives the agent-type battery replacement service is the same as the case in which the user U1 receives the agent-type charging service.

As a variation of the present embodiment, the user vehicle may function as a notification apparatus instead of the server apparatus 20. In such a variation, upon detecting an act or omission of the service staff 11 against the user vehicle, while the agent-type service is provided, that is different from boarding the user vehicle in order to drive the user vehicle, the user vehicle transmits notification data to the terminal apparatus 30.

In an example, the notification apparatus may be used to provide MaaS, a service that leverages mobility.

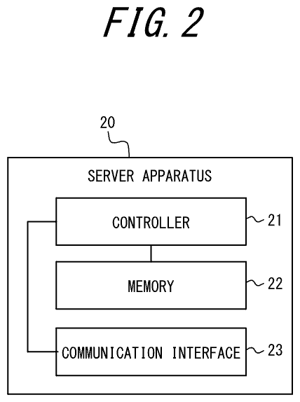

A configuration of the server apparatus 20 according to the present embodiment will be described with reference to FIG. 2.

The server apparatus 20 includes a controller 21, a memory 22, and a communication interface 23.

The controller 21 includes at least one processor, at least one programmable circuit, at least one dedicated circuit, or any combination thereof. The processor is a general purpose processor such as a CPU or a GPU, or a dedicated processor that is dedicated to specific processing. The term “CPU” is an abbreviation of central processing unit. The term “GPU” is an abbreviation of graphics processing unit. The programmable circuit is, for example, an FPGA. The term “FPGA” is an abbreviation of field-programmable gate array. The dedicated circuit is, for example, an ASIC. The term “ASIC” is an abbreviation of application specific integrated circuit. The controller 21 executes processes related to operations of the server apparatus 20 while controlling components of the server apparatus 20.

The memory 22 includes at least one semiconductor memory, at least one magnetic memory, at least one optical memory, or any combination thereof. The semiconductor memory is, for example, RAM, ROM, or flash memory. The term “RAM” is an abbreviation of random access memory. The term “ROM” is an abbreviation of read only memory. The RAM is, for example, SRAM or DRAM. The term “SRAM” is an abbreviation of static random access memory. The term “DRAM” is an abbreviation of dynamic random access memory. The ROM is, for example, EEPROM. The term “EEPROM” is an abbreviation of electrically erasable programmable read only memory. The flash memory is, for example, SSD. The term “SSD” is an abbreviation of solid-state drive. The magnetic memory is, for example, HDD. The term “HDD” is an abbreviation of hard disk drive. The memory 22 functions as, for example, a main memory, an auxiliary memory, or a cache memory. The memory 22 stores data to be used for operations of the server apparatus 20 and data obtained by the operations of the server apparatus 20.

The communication interface 23 includes at least one communication module. The communication module is, for example, a module compatible with a wired LAN communication standard such as Ethernet® (Ethernet is a registered trademark in Japan, other countries, or both) or a wireless LAN communication standard such as IEEE802.11. The name “IEEE” is an abbreviation of Institute of Electrical and Electronics Engineers. The communication interface 23 communicates with the terminal apparatus 30. The communication interface 23 also communicates with the mobile device held by the service staff 11. The communication interface 23 receives data to be used for the operations of the server apparatus 20, and transmits data obtained by the operations of the server apparatus 20.

The functions of the server apparatus 20 are realized by execution of a server program according to the present embodiment by a processor serving as the controller 21. That is, the functions of the server apparatus 20 are realized by software. The server program causes a computer to execute the operations of the server apparatus 20, thereby causing the computer to function as the server apparatus 20. That is, the computer executes the operations of the server apparatus 20 in accordance with the server program to thereby function as the server apparatus 20.

The program can be stored on a non-transitory computer readable medium. The non-transitory computer readable medium is, for example, flash memory, a magnetic recording device, an optical disc, a magneto-optical recording medium, or ROM. The program is distributed, for example, by selling, transferring, or lending a portable medium such as an SD card, a DVD, or a CD-ROM on which the program is stored. The term “SD” is an abbreviation of Secure Digital. The term “DVD” is an abbreviation of digital versatile disc. The term “CD-ROM” is an abbreviation of compact disc read only memory. The program may be distributed by storing the program in a storage of a server and transferring the program from the server to another computer. The program may be provided as a program product.

For example, the computer temporarily stores, in a main memory, a program stored in a portable medium or a program transferred from a server. Then, the computer reads the program stored in the main memory using a processor, and executes processes in accordance with the read program using the processor. The computer may read a program directly from the portable medium, and execute processes in accordance with the program. The computer may, each time a program is transferred from the server to the computer, sequentially execute processes in accordance with the received program. Instead of transferring a program from the server to the computer, processes may be executed by a so-called ASP type service that realizes functions only by execution instructions and result acquisitions. The term “ASP” is an abbreviation of application service provider. Programs encompass information that is to be used for processing by an electronic computer and is thus equivalent to a program. For example, data that is not a direct command to a computer but has a property that regulates processing of the computer is “equivalent to a program” in this context.

Some or all of the functions of the server apparatus 20 may be realized by a programmable circuit or a dedicated circuit serving as the controller 21. That is, some or all of the functions of the server apparatus 20 may be realized by hardware.

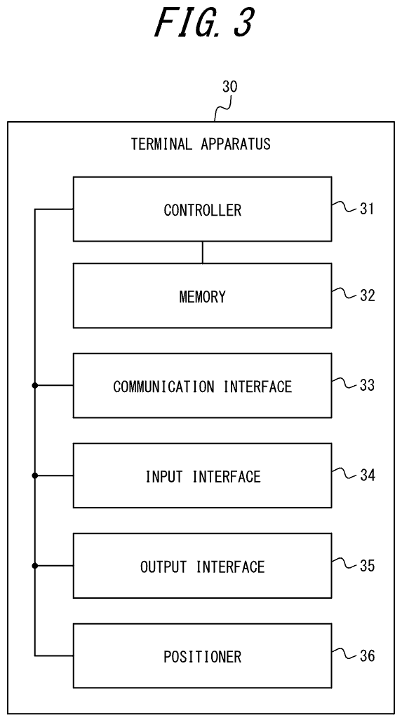

A configuration of the terminal apparatus 30 according to the present embodiment will be described with reference to FIG. 3.

The terminal apparatus 30 includes a controller 31, a memory 32, a communication interface 33, an input interface 34, an output interface 35, and a positioner 36.

The controller 31 includes at least one processor, at least one programmable circuit, at least one dedicated circuit, or any combination thereof. The processor is a general purpose processor such as a CPU or a GPU, or a dedicated processor that is dedicated to specific processing. The programmable circuit is, for example, an FPGA. The dedicated circuit is, for example, an ASIC. The controller 31 executes processes related to operations of the terminal apparatus 30 while controlling components of the terminal apparatus 30.

The memory 32 includes at least one semiconductor memory, at least one magnetic memory, at least one optical memory, or any combination thereof. The semiconductor memory is, for example, RAM, ROM, or flash memory. The RAM is, for example, SRAM or DRAM. The ROM is, for example, EEPROM. The flash memory is, for example, SSD. The magnetic memory is, for example, HDD. The memory 32 functions as, for example, a main memory, an auxiliary memory, or a cache memory. The memory 32 stores data to be used for the operations of the terminal apparatus 30 and data obtained by the operations of the terminal apparatus 30.

The communication interface 33 includes at least one communication module. The communication module is, for example, a module compatible with a mobile communication standard such as LTE, the 4G standard, or the 5G standard, a wireless LAN communication standard such as IEEE802.11. The term “LTE” is an abbreviation of Long Term Evolution. The term “4G” is an abbreviation of 4th generation. The term “5G” is an abbreviation of 5th generation. The communication interface 33 communicates with the server apparatus 20. The communication interface 33 may communicate with the mobile device held by the service staff 11. The communication interface 33 receives data to be used for the operations of the terminal apparatus 30, and transmits data obtained by the operations of the terminal apparatus 30.

The input interface 34 is, for example, a physical key, a capacitive key, a pointing device, a touch screen integrally provided with a display, a visible light camera, a LiDAR sensor, or a microphone. The term “LiDAR” is an abbreviation of light detection and ranging. The input interface 34 accepts an operation for inputting data to be used for the operations of the terminal apparatus 30. The input interface 34, instead of being included in the terminal apparatus 30, may be connected to the terminal apparatus 30 as an external input device. As an interface for connection, an interface compliant with a standard such as USB, HDMI® (HDMI is a registered trademark in Japan, other countries, or both), or Bluetooth® (Bluetooth is a registered trademark in Japan, other countries, or both) can be used. The term “USB” is an abbreviation of Universal Serial Bus. The term “HDMI®” is an abbreviation of High-Definition Multimedia Interface.

The output interface 35 is, for example, a display or a speaker. The display is, for example, an LCD or an organic EL display. The term “LCD” is an abbreviation of liquid crystal display. The term “EL” is an abbreviation of electro luminescent. The output interface 35 outputs data obtained by the operations of the terminal apparatus 30. The output interface 35, instead of being included in the terminal apparatus 30, may be connected to the terminal apparatus 30 as an external output device. As an interface for connection, an interface compliant with a standard such as USB, HDMI® (HDMI is a registered trademark in Japan, other countries, or both), or Bluetooth® (Bluetooth is a registered trademark in Japan, other countries, or both) can be used.

The positioner 36 includes at least one GNSS receiver. The term “GNSS” is an abbreviation of global navigation satellite system. GNSS is, for example, GPS, QZSS, BDS, GLONASS, or Galileo. The term “GPS” is an abbreviation of Global Positioning System. The term “QZSS” is an abbreviation of Quasi-Zenith Satellite System. QZSS satellites are called quasi-zenith satellites. The term “BDS” is an abbreviation of BeiDou Navigation Satellite System. The term “GLONASS” is an abbreviation of Global Navigation Satellite System. The positioner 36 measures the position of the terminal apparatus 30.

The functions of the terminal apparatus 30 are realized by execution of the terminal program according to the present embodiment by a processor serving as the controller 31. That is, the functions of the terminal apparatus 30 are realized by software. The terminal program causes a computer to execute the operations of the terminal apparatus 30, thereby causing the computer to function as the terminal apparatus 30. That is, the computer executes the operations of the terminal apparatus 30 in accordance with the terminal program to thereby function as the terminal apparatus 30.

Some or all of the functions of the terminal apparatus 30 may be realized by a programmable circuit or a dedicated circuit serving as the controller 31. That is, some or all of the functions of the terminal apparatus 30 may be realized by hardware.

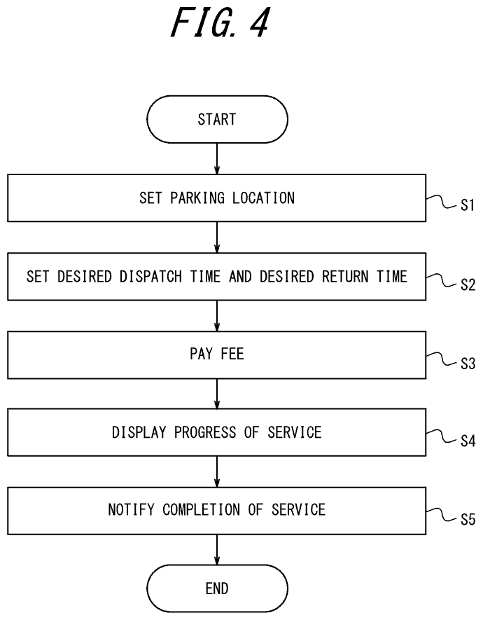

With reference to FIG. 4, operations of the service provision system 10 according to the present embodiment will be described. The operations described below correspond to a service provision method according to the present embodiment. In other words, the service provision method according to the present embodiment includes steps S1 through S5 illustrated in FIG. 4.

When a user U1 starts the terminal program to request the supply service or selects a specific item such as “request service” on a menu screen of the terminal program, step S1 is executed.

In S1, the controller 31 of the terminal apparatus 30 accepts, via the input interface 34, a first user operation to specify a parking location. In the first user operation, not only is the parking location specified, but also information regarding the details of the parking location may be input. The information to be input may include, for example, the name of a building when the parking location is in or adjacent to the building. The information to be input may include information on a parking lot, such as whether the parking lot is on the ground, on the basement, or with a roof, or a parking lot number. The information to be input may include, for example, a photograph of the area around the user vehicle V1 when the user U1 has already parked the user vehicle V1 in the parking location.

In S2, the controller 31 of the terminal apparatus 30 accepts, via the input interface 34, a second user operation to input a desired dispatch time and a desired return time. The desired dispatch time corresponds to the time when the service staff 11 picks up the user vehicle V1, as desired by the user U1. The desired return time corresponds to the time when the service staff 11 returns the user vehicle V1 after charging or battery replacement, as desired by the user U1.

In S3, the controller 31 of the terminal apparatus 30 accepts, via the input interface 34, a third user operation to pay for the supply service. In the third user operation, a fee may be paid with a fixed payment method or a payment method may be selected. Payment method options include, for example, paying a package rate applied within a specific area, consuming a single use of the number of uses set in subscription, or paying a one-time fee. The controller 31 of the terminal apparatus 30 transmits the request data to the server apparatus 20 via the communication interface 33. The request data is data requesting the supply service with indication of the parking location that is specified by the first user operation in S1. The request data may include the information regarding the details of the parking location, as input by the first user operation. In the present embodiment, the request data includes data indicating the desired dispatch time and the desired return time input by the second user operation in S2. The request data may include data indicating a payment method selected by the third user operation. Upon receiving the request data from the terminal apparatus 30 via the communication interface 23, the controller 21 of the server apparatus 20 automatically processes payment for the supply service according to the received request data. Once the automatic process of payment is completed, the controller 21 of the server apparatus 20 performs a process of dispatching the service staff 11 to the parking location indicated by the request data. Specifically, the controller 21 of the server apparatus 20 notifies, of the request data, a manager who selects the type of the supply service according to the positional relationship between the service staff 11 and the parking location and dispatches the service staff 11 to the parking location. Alternatively, the controller 21 of the server apparatus 20 may automatically select the type of the supply service according to the positional relationship between the service staff 11 and the parking location, and dispatch the service staff 11 to the parking location. For example, when the distance or time required from the position of a worker, as the service staff 11, to the parking location is less than or equal to a threshold value, the controller 21 of the server apparatus 20 transmits instruction data via the communication interface 23 to a mobile device held by the worker. The instruction data is data instructing the worker to provide the agent-type charging service or the agent-type battery replacement service. The instruction data may include the information regarding the details of the parking location. The instruction data may include the data indicating the desired dispatch time and the desired return time.

In S4, the controller 21 of the server apparatus 20 monitors the progress of the supply service. Specifically, the controller 21 of the server apparatus 20 monitors the progress of the agent-type charging service or the agent-type battery replacement service by communicating via the communication interface 23 with the mobile device held by the worker. The controller 21 of the server apparatus 20 notifies the terminal apparatus 30 of the progress via the communication interface 23. The controller 31 of the terminal apparatus 30 displays the progress to the display as the output interface 35.

In the present embodiment, upon detecting an act or omission of the service staff 11 against the user vehicle V1, while the supply service is provided, that is different from boarding the user vehicle V1 in order to drive the user vehicle V1, the controller 21 of the server apparatus 20 transmits notification data to the terminal apparatus 30 via the communication interface 23. The notification data is data notifying the user U1 of the detected act or omission. Acts to be detected include, for example, opening a door other than the door of the driver seat of the user vehicle V1, sitting in a seat other than the driver seat of the user vehicle V1, looking into the rear seat of the user vehicle V1, or opening the trunk of the user vehicle V1. Omissions to be detected include, for example, not attaching a dirt-preventive seat cover to the driver seat of the user vehicle V1, not performing a cleaning work of the user vehicle V1, or not capturing a video of the inside of or the area around the user vehicle V1.

The controller 31 of the terminal apparatus 30 may transmit demand data to the server apparatus 20 via the communication interface 33. The demand data is data demanding to view a video of the inside of or the area around the user vehicle V1 that is captured while the supply service is provided. Upon receiving the demand data from the terminal apparatus 30 via the communication interface 23, the controller 21 of the server apparatus 20 transmits the demanded video to the terminal apparatus 30 via the communication interface 23. To better protect privacy, access to the video may be restricted using a digital key.

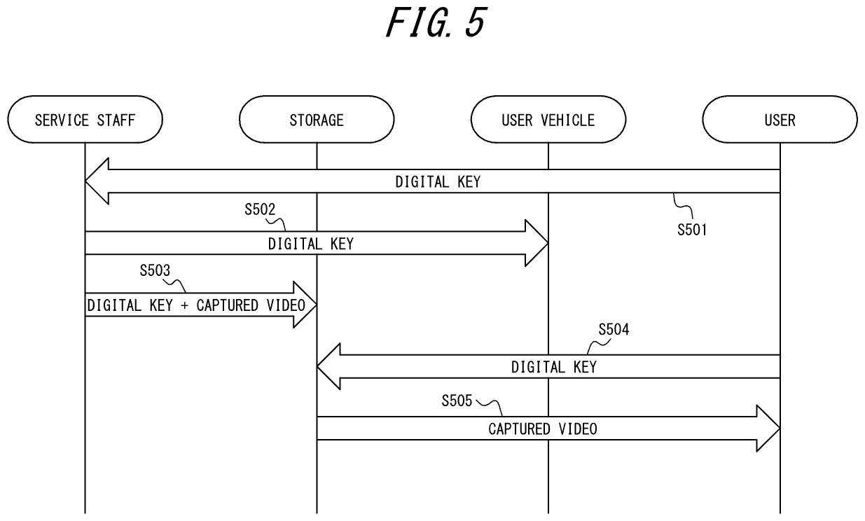

An example of a digital key usage procedure is illustrated in FIG. 5. In S501, the user U1 issues a digital key in the application of the terminal apparatus 30 at the time of the supply service request. The worker as the service staff 11 receives the digital key via SMS or other means of communication. The term “SMS” is an abbreviation of short message service. In S502, the worker uses the digital key to unlock a door of the user vehicle V1 when providing the supply service. In S503, the worker places a mobile device such as a smartphone in the user vehicle V1 and uploads the video captured by the camera of the mobile device to a dedicated site of the server apparatus 20 in association with the digital key issued by the user U1. In S504, the user U1 uses the digital key to access the dedicated site of the server apparatus 20. If the authentication with the digital key is successful, in S505, the user U1 views the video stored in a storage such as the memory 22 of the server apparatus 20. The digital key may be used to encrypt and decrypt the video instead of being used for the authentication.

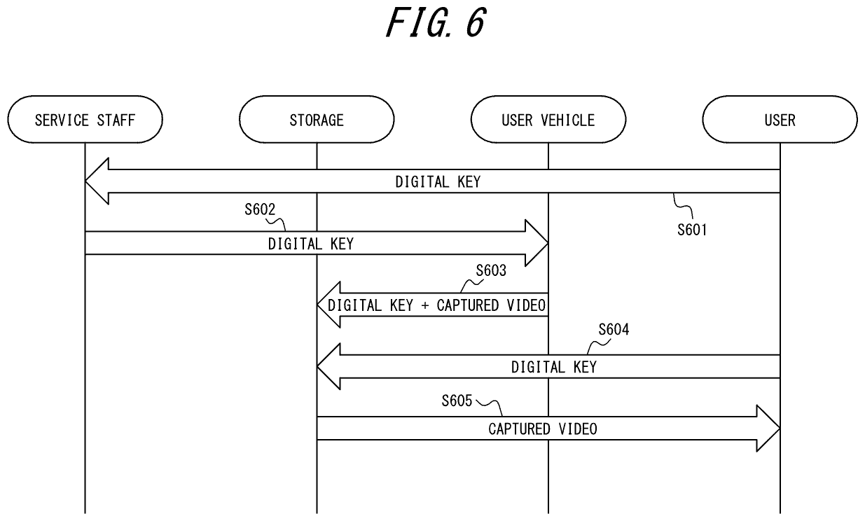

Another example of the digital key usage procedure is illustrated in FIG. 6. Steps S601 and S602 are the same as steps S501 and S502, and thus a description thereof is omitted. In S603, the user vehicle V1 uploads the video captured by the in-vehicle camera to the dedicated site of the server apparatus 20 in association with the digital key used to unlock the door. Steps S604 and S605 are the same as steps S504 and S505, and thus a description thereof is omitted.

In S5, upon detecting completion of the supply service, the controller 21 of the server apparatus 20 notifies the terminal apparatus 30 of the completion via the communication interface 23. The controller 31 of the terminal apparatus 30 displays a screen indicating that the supply service has been completed, on the display as the output interface 35. In this screen, information regarding the position where the worker has stopped the user vehicle V1 may be displayed. A photograph of the user vehicle V1 taken by the worker may be displayed.

In an example, the above processing steps may be executed when providing a service (MaaS) using the server apparatus 20 or the user vehicle V1, either serving as a notification apparatus. In this case, the information processing method according to the above processing steps is an example of a method of providing a service (MaaS) using the server apparatus 20 or the user vehicle V1, either serving as a notification apparatus.

The present disclosure is not limited to the embodiment described above. For example, two or more blocks described in the block diagrams may be integrated, or a block may be divided. Instead of executing two or more steps described in the flowcharts in chronological order in accordance with the description, the steps may be executed in parallel or in a different order according to the processing capability of the apparatus that executes each step, or as required. Other modifications can be made without departing from the spirit of the present disclosure.

1. A notification apparatus comprising:
a communication interface configured to communicate with a terminal apparatus configured to request a service to dispatch a service staff to a location in which a user vehicle is parked, cause the dispatched service staff to move the user vehicle to another location, and supply an energy source to the user vehicle in a location to which the user vehicle is moved; and
a controller configured to, upon detecting an act or omission of the service staff against the user vehicle, while the service is provided, that is different from boarding the user vehicle in order to drive the user vehicle, transmit notification data notifying a user of the detected act or omission to the terminal apparatus via the communication interface.

2. The notification apparatus according to claim 1, wherein the act includes opening a door other than a door of a driver seat of the user vehicle, sitting in a seat other than the driver seat of the user vehicle, looking into a rear seat of the user vehicle, or opening a trunk of the user vehicle.

3. The notification apparatus according to claim 1, wherein the omission includes not attaching a dirt-preventive seat cover to a driver seat of the user vehicle, not performing a cleaning work of the user vehicle, or not capturing a video of an inside of or an area around the user vehicle.

4. The notification apparatus according to claim 1, wherein the controller is configured to, upon receiving demand data demanding to view a video of an inside of or an area around the user vehicle that is captured while the service is provided from the terminal apparatus via the communication interface, transmit the video to the terminal apparatus via the communication interface.

5. The notification apparatus according to claim 1, wherein the service includes a charging service to supply the energy source to the user vehicle by charging a battery installed in the user vehicle, or a battery replacement service to supply the energy source to the user vehicle by replacing the battery installed in the user vehicle with another battery.

6. A method, by a processor, for improving travel mobility as a service (MaaS), comprising processing steps executed by the notification apparatus according to claim 1.
